(19) United States
(12) Patent Application Publication
(10) Pub. No.: US 2020/0051726 A1
(43) Pub. Date: Feb. 13, 2020

(54) Magnetizer and Demagnetizer

(71) Applicant: Daniel Pearson, Fort Worth, TX (US)

(72) Inventor: Daniel Pearson, Fort Worth, TX (US)

(21) Appl. No.: 16/058,675

(22) Filed: Aug. 8, 2018

(51) Int. Cl. H01F 13/00; B25B 23/12

(52) U.S. Cl. CPC H01F 13/00; B25B 23/12

(57) ABSTRACT

A device for magnetizing and demagnetizing a ferrous object, such as a screwdriver, said device having a plurality of magnets disposed about at least one magnetization opening and beside at least one demagnetization opening, said demagnetization opening configured such that the location and orientation of the ferrous object are fixed relative to the magnets and optimized for demagnetization.

### RELATED APPLICATION

This application claims priority to U.S. Provisional Application No. 62/543,168 entitled “Magnetizer and Demagnetizer” filed Aug. 9, 2017, the contents of which are incorporated by reference hereto in their entirety.

### TECHNICAL FIELD

This disclosure relates generally to magnetizing and demagnetizing devices and, more particularly, to devices for magnetizing and demagnetizing hand tools such as screwdrivers.

### BACKGROUND

This disclosure relates to magnetizers, and particularly to handheld magnetizers used by electricians and other tradesmen to impart a magnetic charge to various hand tools, most commonly screwdrivers. These magnetizers typically employ a pair of magnets spaced parallel to one another such that the magnetic flux between the two magnets is strong enough to impart an induced and permanent magnetic charge to a ferrous shaft inserted between them. Because both screwdrivers and screws are typically made of ferrous materials, such devices are often used to magnetize a screwdriver, allowing it to attract and hold a screw reliably until it is used as a fastener.

U.S. Pat. No. 3,467,926 to Smith discloses a typical magnetizing and demagnetizing device in the prior art. The device disclosed in the Smith patent features a slot set between a pair of elongated strip magnets with opposed poles facing the slot, such that a screwdriver can be inserted between the two magnets by inserting it into the slot. The Smith patent also discloses a method of demagnetization, instructing that the screwdriver may be demagnetized by drawing the magnetized screwdriver against a corner of the magnetizing device at an undisclosed angle. While this is likely to reverse to some degree the effect of magnetization on the screwdriver, it is imprecise and is likely to only partially demagnetize the tool, and will most likely leave the screwdriver in a weaker yet still magnetized state.

U.S. Pat. No. 3,662,303 to Arllof discloses a similar method of magnetizing and demagnetizing a screwdriver. In the Arllof type of magnetizing device, two bar magnets are mounted within an enclosure with springs biasing them together such that a slotted screwdriver can be forced between the two magnets to impart a magnetic charge to the screwdriver. The Arllof device teaches that in order to demagnetize the screwdriver, a user must remove the bar magnets magnetizer body and invert one of them, such that the poles in the chamber are now identical. While this method will accurately demagnetize the screwdriver, it is tedious and difficult to execute, particularly because the bar magnets will tend to vigorously repel one another when the user tries to put them in the prescribed demagnetization mode.

U.S. Pat. No. 6,249,199 to Liu discloses a magnetization and demagnetization device employing sintered magnets, which are more commonly known to the public as “rare earth magnets” and are typically made with neodymium. Like the Smith device, the Liu device features an enclosure which carries opposed-pole magnets on opposite sides of a slot through which a screwdriver is to be inserted and thus magnetized. Liu teaches that in order to demagnetize the screwdriver, it should be drawn across the top of the device, such that the opposite pole acts upon the screwdriver, reversing the effect of the magnetization. Also as in the Smith device, the Liu device is a crude demagnetization, failing to accurately account for the requirements of the demagnetization and is likely to leave many screwdrivers partially magnetized.

Magnetizer blocks containing a magnetizing zone and a demagnetizing zone have become common, largely employing methods similar to the Smith and Liu devices. However, these magnetizer blocks share the same common drawbacks, namely that demagnetization is imprecise and sometimes ineffective.

The present invention addresses these variances in demagnetization of ferrous objects, including hand tools such as screwdrivers, by fixing the position and orientation of the screwdriver at a pre-calculated position and orientation for optimal demagnetization. In the illustrated embodiment, the device is enclosed in a molded plastic case containing a pair of rare earth magnets.

### SUMMARY

In one aspect, the disclosure describes a magnetizing and demagnetizing device including a body forming at least one magnetizing opening extending transversely to the longitudinal axis of the body. In one exemplary embodiment, the at least one magnetizing opening extends from a front side of the body to a rear side of the body. A pair of strong rare earth magnets are disposed in a parallel fashion about the at least one magnetizing opening, such that the poles on opposite sides of the at least one magnetizing opening are alike. This at least one magnetizing opening and its associated magnets form a magnetizing zone, allowing the user to insert a screwdriver or other ferrous workpiece anywhere in the at least one magnetizing opening to impart a magnetic charge upon it. The one exemplary embodiment includes also at least one demagnetizing opening situated at a precisely calculated location on the opposite side of one of the magnets from the at least one magnetizing opening. The at least one demagnetizing zone is located at a distance from the magnet calculated to expose the screwdriver to an optimal demagnetization effect, and is shaped in such a manner that the screwdriver can be inserted only in the optimal orientation. By fixing the precise distance and orientation of the driver from the magnet, the demagnetization effect can be maximized.

### BRIEF DESCRIPTION OF THE DRAWINGS

FIG. 1 is a perspective view of a prior art magnetizing and demagnetizing device in a magnetizing configuration.

FIG. 2 is a perspective view of the device of FIG. 1 in a demagnetizing configuration.

FIG. 3 is a depiction of the magnetic field between like poles of two magnets and a corresponding magnetization zone.

FIG. 4 is a depiction of the magnetic field surrounding a single pole of a magnet and a corresponding demagnetization zone.

FIG. 5 is a perspective view of a magnetizing and demagnetizing device in accordance with the disclosure.

FIG. 6 is a perspective view of the interior of the magnetizing and demagnetizing device in FIG. 5.

FIG. 7 is a perspective view of a means of magnetization using a device similar to the magnetizing and demagnetizing device in FIG. 5.

FIG. 8 is a perspective view of a means of magnetization using a device similar to the magnetizing and demagnetizing device in FIG. 5.

### DETAILED DESCRIPTION

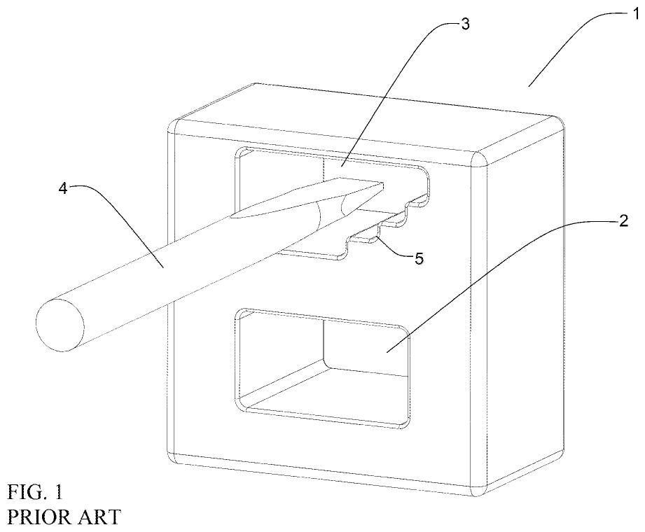

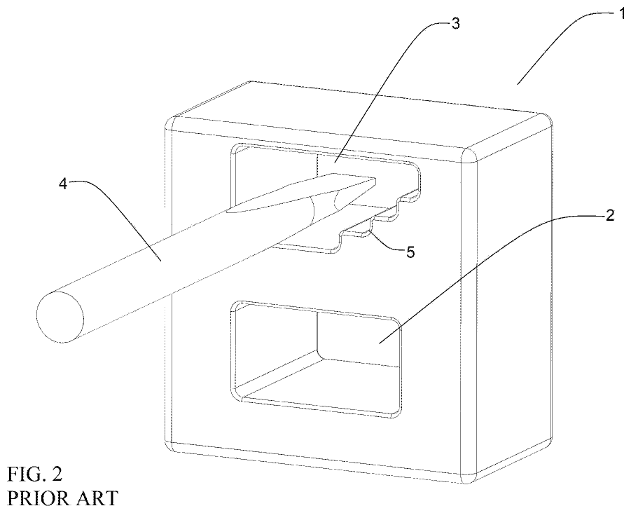

FIG. 1 and FIG. 2 depict a magnetizing and demagnetizing device common in the prior art. The prior art device 1 features a magnetization zone 2 and a demagnetization zone 3. As seen in FIG. 1, the magnetization zone 2 allows a screwdriver 4 to be inserted between two magnets of opposed polarity (not shown) in order to impart a magnetic charge on the screwdriver 4. As seen in FIG. 2, the demagnetization zone 3 is situated beyond one of the magnets (not shown) to reverse the magnetization imparted to the screwdriver 4 that was previously placed in the magnetization zone 2. A series of steps 5 is incorporated into the demagnetization zone 3 to allow the user to vary the amount of demagnetization effect the tool experiences. However, this system does not instruct the user which of the steps 3 is applicable to any given screwdriver 4, and does not control the overall position or orientation of the screwdriver 4. If the demagnetization effect imparted in the demagnetization zone 3 is not strong enough, the screwdriver 4 will retain a magnetic charge. If the demagnetization effect is too great, it will negate the magnetic charge on the screwdriver 4 and impart another magnetic charge, of opposite polarity, to the screwdriver 4.

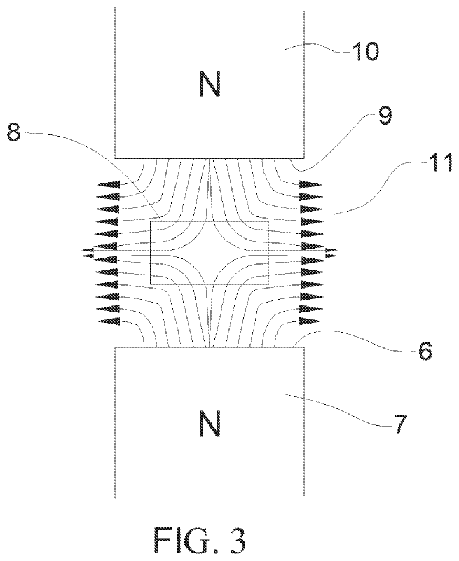

FIG. 3 is a diagram of the lines of magnetic flux 11 present in the magnetization zone 8 which might be present in the prior art device 1. The north pole 6 of a first magnet 7 is situated on one side of the magnetization zone 8 exerting a strong magnetic field nearest it, while the north pole 9 of a second magnet 10 is placed on the opposite side of the magnetization zone 8 exerting a similarly strong magnetic field nearest it, each such field waning with distance but collectively adding together between the two. The resulting lines of magnetic flux 11 substantially uniformly traverse the magnetization zone 8 such that the magnetizing effect throughout the magnetization zone 8 is substantially constant. Precise positioning of the item to be magnetizing is thus not typically required.

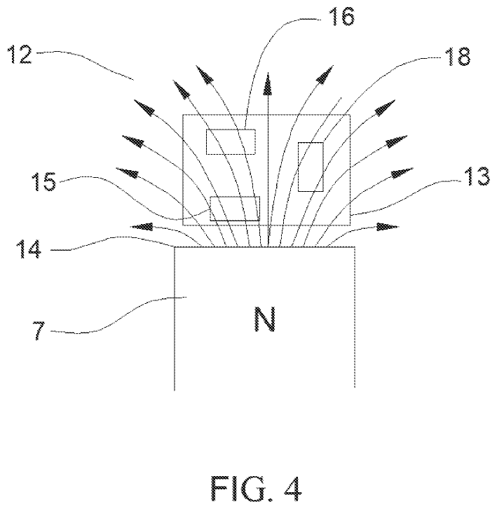

FIG. 4 is a diagram of the lines of magnetic flux 12 which might be present in the demagnetization zone of the prior art device 1. The demagnetization zone 13 is exposed to a south pole 14 of the first magnet 7. Here, the lines of magnetic flux 12 are divergent, and the total magnetic effect imparted on a screwdriver 4 at point of close proximity 15 to the single pole 14 of the first magnet 7 is significantly greater than at a point of greater distance 16 to the single pole 14 of the first magnet 7 over an identical surface area. The demagnetization effect also varies with orientation of a noncircular cross section, offering a lesser proximity to the magnet in a horizontal orientation 16 than in a vertical orientation 18. Accordingly, while the magnetization effect in the magnetization zone 8 is substantially constant, the demagnetization effect in the demagnetization zone 13 varies substantially with distance and orientation of the screwdriver 4.

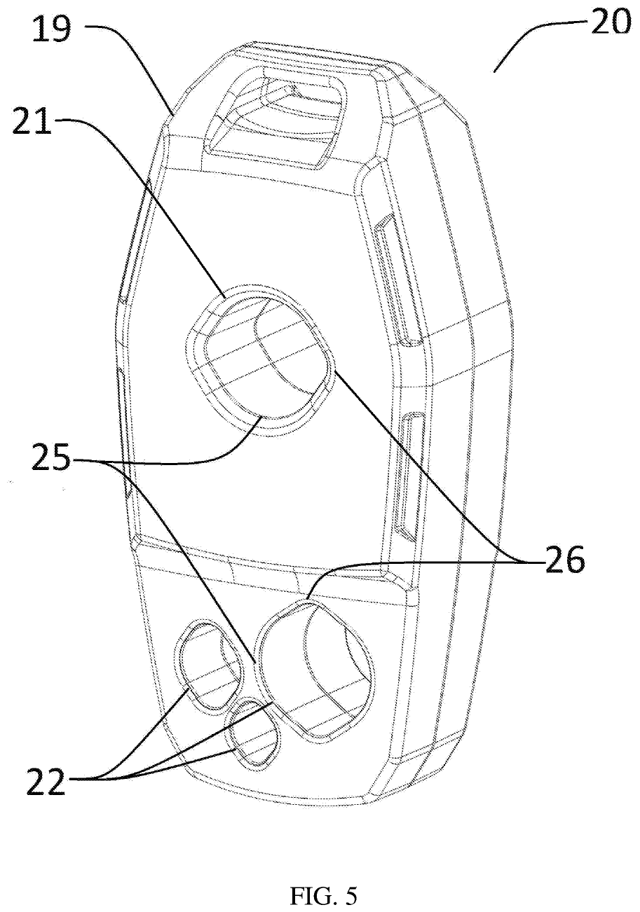

FIG. 5 through FIG. 8 depict one embodiment 20 of the present invention. In FIG. 5 is shown the exterior of this embodiment 20. A nonmagnetic body 19 includes a magnetization opening 21 and a plurality of demagnetization openings 22 configured for the demagnetization of various different ferrous members, in this case particularly screwdrivers. Although multiple shapes may be employed, including circular for round members and oblong or oval for flat members, the magnetization opening 21 and demagnetization openings 22 here are “football shaped” to accommodate multiple types of common screwdrivers. The minor axes 25 of the demagnetization openings 22 are sized to the diameter of certain round diameter screwdrivers, specifically Phillips-drive and square-drive screwdrivers, while the major axis 30 of these openings is sized to accommodate keystone style slotted drivers, which are not uniform in diameter, to fix the orientation of these drivers with respect to the first rare earth magnet 27 and the second rare earth magnet 23 for a precise and predictable magnetic field exposure and thus magnetization and demagnetization effect.

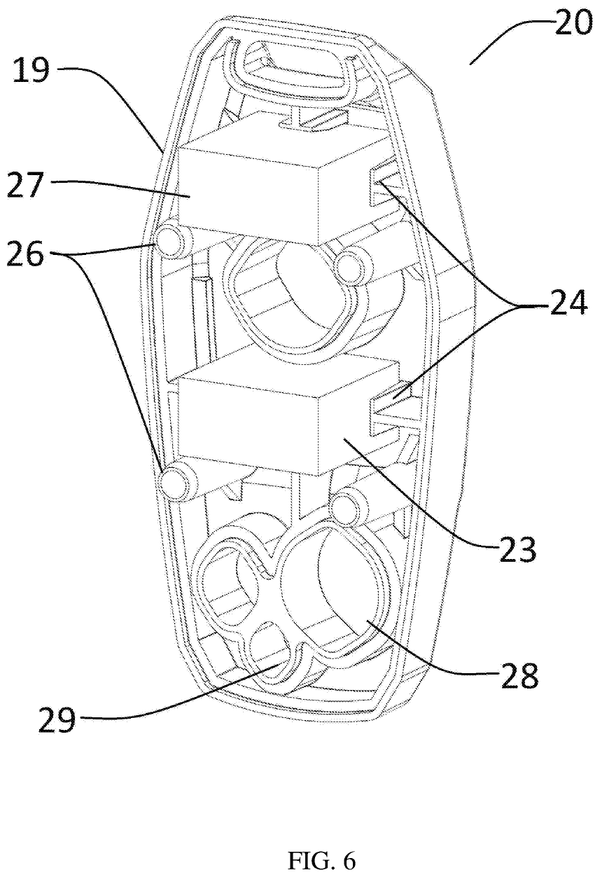

FIG. 6 depicts the interior of the device of FIG. 5, with half of the body 19 removed. A first rare earth magnet 27 and a second rare earth magnet 23 are thus exposed. The first rare earth magnet 27 and the second rare earth magnet 23 are held in place horizontally within the body 19 by means of support posts 24 and by the interior wall 25 of the magnetization opening 21 on the body 19, the halves of which are held together via screw posts 26. With the first rare earth magnet 22 and the second rare earth magnet 23 thus immobilized with respect to the body 19 the magnetic fields across the magnetization opening 21 and demagnetization openings 22 are fixed within their own frame of reference and the magnetic field strength about the first rare earth magnet 27 and the second rare earth magnet 23 can be accurately calculated. The demagnetizing openings 22 are sized and located such that largest demagnetization opening 28, sized for larger screwdrivers which require a greater demagnetization effect to be demagnetized, is located closest to the second rare earth magnet 23, while the smallest demagnetization opening 29, sized for smaller screwdrivers which require a lesser demagnetization effect to be demagnetized, is located furthest from the second rare earth magnet 23. Here, the demagnetization openings 22 are executed as holes through the body 19, but could also be executed as indentations in the periphery of the body 19 achieving a similar result.

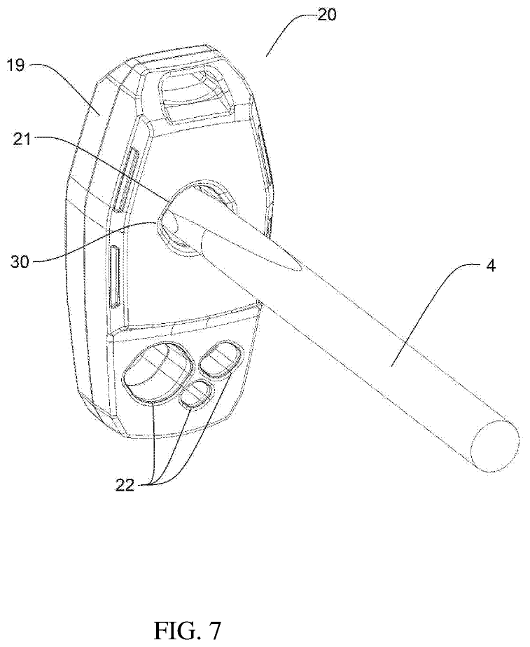

FIG. 7 depicts the magnetization method of a device similar to the device of FIG. 5. An object of a ferrous material, in this case a screwdriver 4 is inserted into the magnetization opening 21, and thus between the first rare earth magnet 27 and the second rare earth magnet 23, and becomes magnetized by the magnetic field between them. The magnetization opening 21 is sized large enough to accommodate all contemplated screwdrivers and need not be calibrated for a particular size or orientation, as the magnetic flux within the magnetizing opening is substantially uniform. The size and position of the first rare earth magnet 27 and the second rare earth magnet 23 are sufficiently chosen such that a single stroke of the screwdriver 4 into the magnetization opening 21 is adequate to magnetize the screwdriver 4.

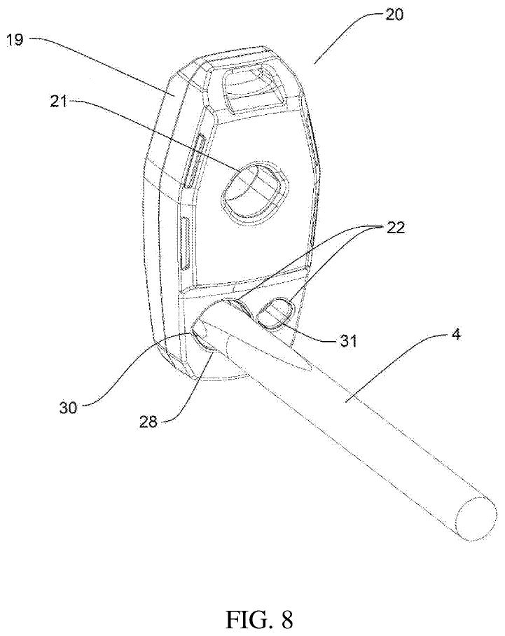

FIG. 8 depicts the demagnetization method of the device of FIG. 8. The ferrous object in FIG. 7, in this case a large slotted keystone screwdriver 4, is inserted into the demagnetization opening 28 properly sized for it, and is bounded by the major axis 30 of the “football-shaped” demagnetization opening 22 such that its position relative to the first rare earth magnet 27 and the second rare earth magnet 23 is fixed. The screwdriver 4 fits snugly into the largest demagnetization opening 28 and would not fit in the small demagnetization opening 31 next to it. The location and orientation of the screwdriver 4 have been pre-calculated to expose the screwdriver 4 to exactly the correct intensity of magnetic field required to counteract the magnetization effect of a single stroke of the screwdriver 4 into the magnetization opening 21. The result is a much more accurate demagnetization effect than is possible with a standard magnetizer and demagnetizer device 1 found in the prior art.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. A magnetizing and demagnetizing device comprising:
a body;
two magnets housed in said body;
a magnetizing opening located in said body such that said magnetizing opening is positioned between said magnets;
a demagnetizing opening located in said body, wherein said demagnetizing opening is positioned with respect to said magnets to accurately demagnetize a ferrous object conforming to the dimensions of said demagnetizing opening.

2. The magnetizing and demagnetizing device of claim 1, wherein said ferrous object is a screwdriver.

3. The magnetizing and demagnetizing device of claim 1, wherein said magnets are disposed with like poles abutting said magnetizing opening.

4. The magnetizing and demagnetizing device of claim 1, wherein said demagnetizing opening is contoured to fix the position of a non-uniform ferrous object.

5. A magnetizing and demagnetizing device comprising:
a body;
two magnets housed in said body;
a magnetizing opening located in said body such that said magnetizing opening is positioned between said magnets;
a plurality of demagnetizing openings located in said body, wherein said demagnetizing openings are not uniform in size.

6. The magnetizing and demagnetizing device of claim 5, wherein said ferrous object is a screwdriver.

7. The magnetizing and demagnetizing device of claim 5, wherein said magnets are disposed with like poles abutting said magnetizing opening.

8. The magnetizing and demagnetizing device of claim 5, wherein said demagnetizing opening is contoured to fix the position of a non-uniform ferrous object.

9. A device for magnetizing and demagnetizing a screwdriver comprising:
a body;
two magnets housed in said body;
a magnetizing opening located in said body such that said magnetizing opening is positioned between said magnets;
a demagnetizing opening located in said body, wherein the shape of said demagnetizing opening has a minor axis conforming to the diameter of a round shank screwdriver and a major axis conforming to the blade of a keystone screwdriver.

10. The magnetizing and demagnetizing device of claim 5, wherein said magnets are disposed with like poles abutting said magnetizing opening.
